(19) United States
(12) Patent Application Publication
(10) Pub. No.: US 2007/0180754 A1
(43) Pub. Date: Aug. 9, 2007

(54) Decoy apparatus

(75) Inventors: Scott Neeley, Ogden, UT (US); Garrett Woolsey, Ogden, UT (US)

Correspondence Address: VAN COTT, BAGLEY, CORNWALL & MCCARTHY, P.O. BOX 45340, SALT LAKE CITY, UT, 84145-0340, US

(73) Assignee: Team Goose Spot, LLC

(21) Appl. No.: 11/496,738

(22) Filed: Jul. 31, 2006

Related U.S. Application Data
(60) Provisional application No. 60/771,334, filed on Feb. 8, 2006.

(51) Int. Cl. A01M 31/06

(52) U.S. Cl. 43/3; 43/2

(57) ABSTRACT

An apparatus for imparting motion to a decoy such as, for example, a bird decoy is disclosed and includes a frame positionable on the ground and an upwardly extending support structure having a first end connected to the frame and a second end configured for attachment to the underbelly region of the decoy. In one embodiment, the frame defines a circle lying in a plane surface, and the support structure comprises a first member that extends a first length inward from the frame toward the center of the circle and a second member that extends a second length away from the plane surface at substantially a right angle. Back and forth or circular movement of the decoy occurs in response to wind imparting a force on the decoy, with the frequency and amplitude of movement of the decoy being adjustable through adjustment of the lengths of the first and second members.

### RELATED APPLICATIONS

This present application claims priority to U.S. Provisional Patent Application No. 60/771,334, entitled “Decoy Apparatus,” filed Feb. 8, 2006.

### TECHNICAL FIELD OF THE INVENTION

The present invention relates to decoys and, more specifically, to movable bird or animal decoys, such as geese, duck, turkey, rabbit or varmint decoys.

### BACKGROUND OF THE INVENTION

Decoys have been used to lure animals or birds, such as, for example, turkeys or various varmints, into sufficient range for hunting, observation and study or photography. The goal of decoy design is to provide a life-like appearance that attracts real animals or birds. Prior art designs have included, for example, both stationary decoys and decoys that exhibit movement in one or more degrees of freedom. In this regard, the goal is to incorporate the most life-like movement into the decoy in as simple a fashion as possible. The apparatus of the present invention addresses this goal by achieving a life-like three-dimensional movement of an otherwise stationary decoy through a novel support mechanism that is driven by wind or an external force, such as an attached length of string.

### SUMMARY OF THE INVENTION

An apparatus for imparting motion to a decoy such as, for example, a bird or varmint decoy is disclosed and includes a frame positionable on the ground and an upwardly extending support structure having a first end connected to the frame and a second end configured for attachment to the underbelly region of the decoy or to some other convenient location on the interior or exterior of the decoy. In one embodiment, the frame defines a circle lying in a plane surface, and the support structure comprises a rod member that extends a first distance inward from the frame toward the center of the circle and a second distance away from the plane surface at substantially a right angle.

### BRIEF DESCRIPTION OF THE DRAWINGS

FIG. 1 illustrates a side perspective view of the decoy apparatus of the present invention;

FIG. 2 illustrates a second side perspective view of the decoy apparatus of the present invention;

FIG. 3 illustrates a third side perspective view of the decoy apparatus of the present invention with the lower section of a decoy mounted thereto;

FIG. 4 illustrates an underside view of the decoy apparatus of the present invention with the lower section of a decoy mounted thereto;

FIG. 5 illustrates a side view of two embodiments of the present invention, focusing on the mounting assemblies used to mount the decoys to the support structure;

FIG. 6 illustrates a perspective side view of the present invention having a bird decoy mounted thereto; and

FIG. 7 illustrates an underside view of a decoy mounted to one embodiment of the present invention.

### DETAILED DESCRIPTION OF THE INVENTION

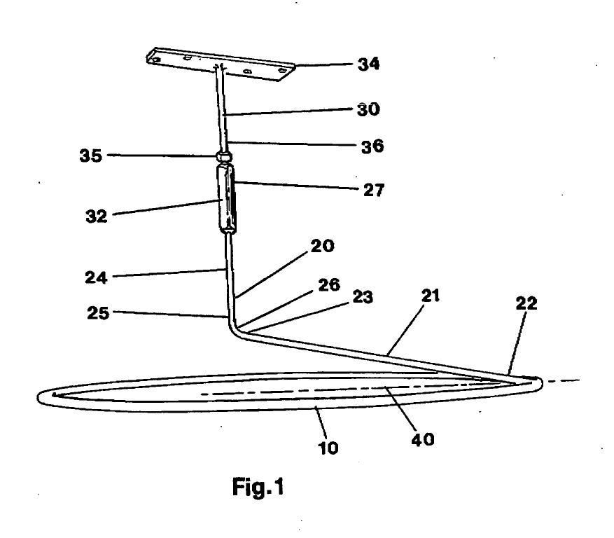

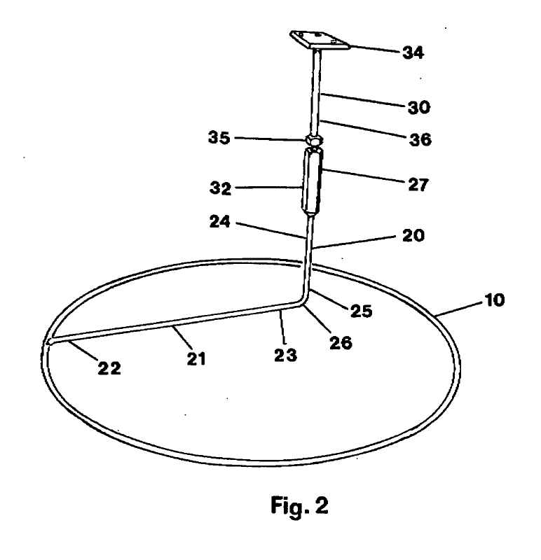

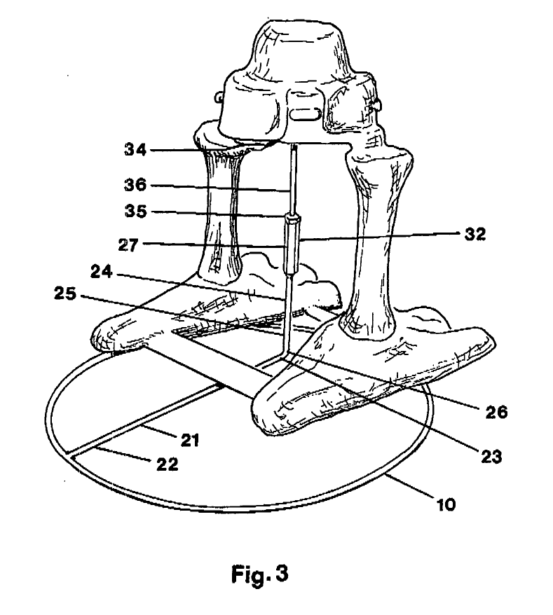

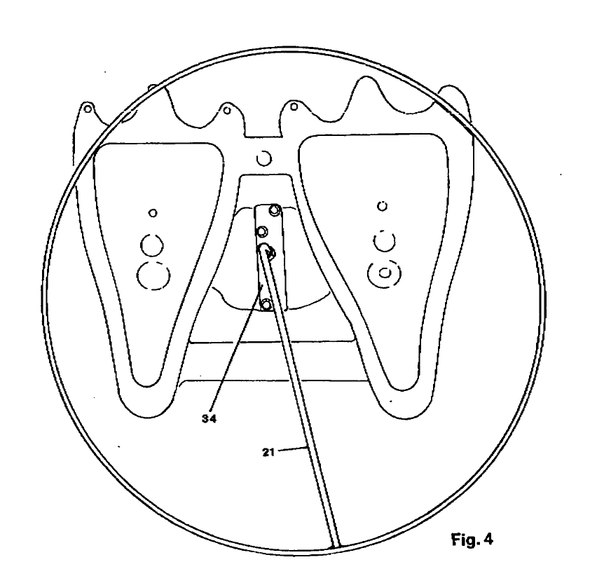

Generally, the present invention relates to an apparatus for decoys and, specifically, to an apparatus for bird decoys. In one embodiment, which is described and illustrated with reference to FIGS. 1 through 4, the apparatus includes a frame 10 that is positionable on the ground. A support structure 20 extends inwardly and upwardly from the frame 10 and is configured to receive a decoy at its free end. More specifically, the support structure 20 includes a first member 21 having a first end 22 that is secured to the frame 10 and a second end 23. The support structure 20 further includes a second member 24 having a first end 25 that is connected to the second end 23 of the first member 21 and a second end 27 that is configured to receive a mounting bracket 30 for the decoy. The first member 21 extends inwardly from the frame 10 and upwardly at a small positive angle 40 with respect to an imaginary plane that extends through the frame 10. The second member 24 extends upwardly at substantially a right angle with respect to the imaginary plane. The second end 23 of the first member 21 and the first end 25 of the second member 24 are joined together at an angle-joint 26.

Positioned at the second end 27 of the second member 24 is a female coupling 32. In one embodiment, the female coupling 32 is sized and configured to receive a mounting bracket 30 for the decoy. The mounting bracket 30 includes a mounting plate 34 that includes one or more holes that are sized to receive bolts extending from the underbelly of the decoy. The mounting bracket 30 further includes a threaded bolt 36 that screws into the female coupling 32 and is secured to the coupling with a locking nut 35. The decoy is fastened securely to the mounting plate 34. In an alternative embodiment, a threaded rod extends from the underbelly of the decoy and engages the female coupling 32 in a fashion similar to that described above with respect to the threaded bolt 36 of the mounting bracket 30.

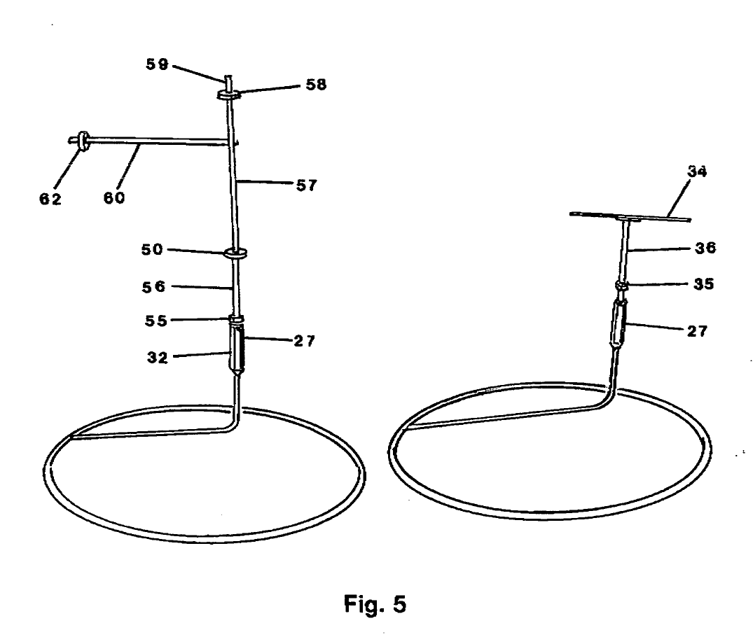

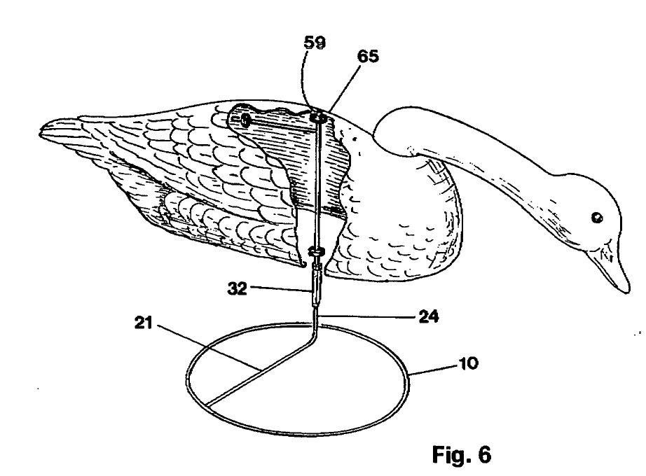

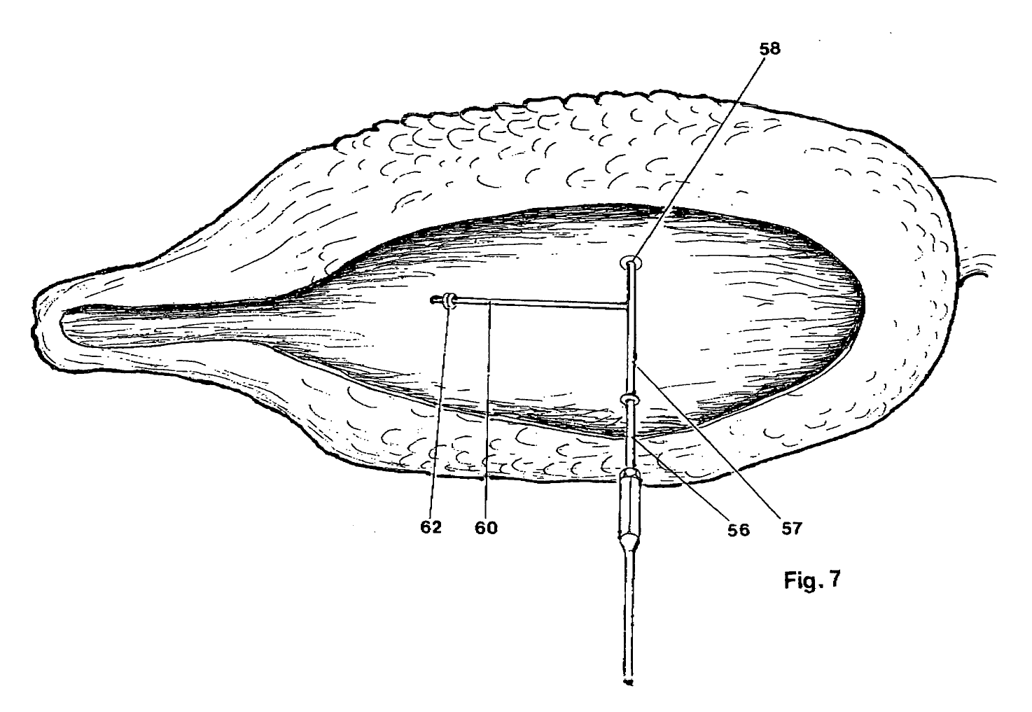

In a still further alternative embodiment, as illustrated in FIGS. 5-7, the decoy is mounted to the support structure using a pin and arm mounting assembly 70. More specifically, the pin and arm mounting assembly 70 includes a threaded bolt 56 that screws into the female coupling 32 and is secured to the coupling 32 with a locking nut 55. A pin 57 extends from the threaded bolt 56 (and may be integral with the bolt) upward to engage the underside of the decoy shell. A washer 58 or the like is secured to the pin 57 near the upper end 59 of the pin 57. An arm 60 extends perpendicularly from the pin 57 and is configured to contact the underside of the decoy shell. A plastic grommet 62 of the like is positioned on the end of the arm 60 to make contact with the underside of the decoy shell. In one embodiment, the decoy shell includes a small hole 65 positioned through the backside of the decoy. The hole 65 is configured to receive the upper end 59 of the pin 57, with the underside of the decoy shell resting on the washer 58 and grommet 62. The underside of the decoy shell is either fixed to the grommet 62, thereby preventing relative movement, or allowed to simply rest of the grommet, thereby allowing additional side to side movement of the shell with respect to the support structure—i.e., with respect to the second member 24.

Regardless of the mounting structure employed, the decoy is removably secured to the support structure 20 and translates in a back and forth or circular movement in response to the wind. Alternatively, a piece of string or the like may be attached to the support structure 20—e.g., to the first member 21 or the second member 24—and intermittently tugged upon to impart back and forth or circular movement to the decoy. If desired, the frame 10 is removably secured to the ground using hooks (not illustrated) having stake members that penetrate the ground. Securing the frame to the ground prevents the decoy apparatus from tipping over in response to the wind of the intermittent tugging on the string.

Movement characteristics of the decoy—e.g., the frequency of back and forth or circular movement—are dependent upon, among other things, the lengths of the respective first member 21 and second member 24. Shortening one or both of the lengths of the respective members 21, 24 will, for example, tend to stiffen the vibrating system—i.e., the support structure 20- and thereby result in a higher frequency of movement of the decoy and a lower maximum amplitude of the back and forth or circular motion. Conversely, lengthening one or both of the respective members 21, 24 will tend to reduce the stiffness of the vibrating system and thereby result in a lower frequency of movement of the decoy and a higher maximum amplitude of the back and forth or circular motion. In similar fashion, a decoy having a lighter mass will tend to result in higher frequencies of movement and lower maximum amplitudes than a decoy having a heavier mass. The present invention contemplates the use of two piece first and second members 21, 24, which facilitates changing or adjusting the lengths of one or both members 21, 24 in the field. The length changing or adjusting concept may also be achieved, for example, by varying the degree to which the threaded bolt 36 is inserted and locked into the female coupling 27 of the second member 24.

A similar length-changing effect may also be obtained through adjustment of the angle 40. In one embodiment, the frame and first and second members 21, 24 are constructed using mild steel rod-like material. The mild steel material permits the angle 40 at the intersection of the first member 21 and the frame 10 to be adjusted and the angle angle-joint 26 to be adjusted. Increasing one or both angles will effectively lengthen the support structure, and thereby result in a lower frequency of movement of the decoy and a higher maximum amplitude of the back and forth or circular motion. Similar to the above discussion, the converse is also true—i.e., decreasing one or more of the angles will result in a higher frequency of movement of the decoy and a lower maximum amplitude of the back and forth or circular motion. Regardless of how accomplished, the length changing or adjusting feature—whether through actual adjustment of one or both lengths of the first and second members 21, 24 or through adjustment of one or both angles 40, 26—is especially helpful where the user of the present invention desires to switch decoys having differing masses in the field or in situations where the velocity of the wind is variable throughout the day.

In one embodiment, the frame 10 defines a circle that lies substantially in an imaginary plane. The circle has a radius of about six inches, although the invention contemplates the use of radii that are between about three inches and about twelve inches or greater. The first member 21 of the support structure 20 extends inward from the perimeter of the circular frame at an angle 40 that is about twenty degrees, although the invention contemplates the use of angles that are between about zero degrees and about forty-five degrees. The first member 21 of the support structure 20 has a length of about seven inches, which is slightly longer than the radius of the circular frame 10. The invention contemplates a length for the first member 21 of the support structure 20 being slightly longer or shorter, but generally on the order of the length of the radius of the frame 10—i.e., within plus or minus about thirty percent of the length of the radius of the frame 10.

In the same embodiment, the second member extends away from the frame 10 at substantially a right angle with respect to the imaginary plane, although the invention contemplates angles that are within plus or minus twenty degrees with respect to a right angle. The second member 24 of the support structure 20 has a length of about four and one-half inches and the visible portion of the threaded bolt 36 of the mounting bracket 30 has a length of about three and one-half inches. The combined lengths of the second member 24 and the threaded bolt 36 are also generally on the order of the length of the radius of the frame 10—i.e., within plus or minus about thirty percent of the length of the radius of the frame 10.

In one embodiment, the first member 21 and the second member 24 are comprised of a single steel rod that includes a smooth bend in the vicinity of the angle-joint 26. Also contemplated by the present invention is, however, a two-piece assembly that can be detachably joined by a coupling positioned in the vicinity of the angle-joint 26. A coupling positioned at the junction of the frame 10 and the first member 21 is also contemplated for detachable joining of the identified components. In one embodiment, each of the frame 10, the first and second members 21, 24, and the mounting bracket 30 are constructed using mild steel rod. Alternative materials for construction include aluminum and carbon fiber or similar composite materials. Indeed, in certain applications, it may be desirable to construct the apparatus using a combination of components constructed using different materials—e.g., using steel to construct the frame 10 and the first and second members 21, 24 and carbon fiber to construct the mounting bracket 30.

While certain embodiments and details have been included herein and in the attached invention disclosure for purposes of illustrating the invention, it will be apparent to those skilled in the art that various changes in the methods and apparatuses disclosed herein may be made without departing form the scope of the invention, which is defined in the appended claims.

What is claimed is:

1. An apparatus for imparting motion to a bird decoy, comprising:
a frame positionable on the ground, the frame having an outer perimeter that lies substantially in a plane surface;
a support structure having
a first member connected to the outer perimeter of the frame and extending inward of the outer perimeter at an angle with respect to the plane surface, and
a second member connected to the first member and extending away from the frame substantially at a right angle with respect to the plane surface.

2. The apparatus of claim 1, wherein the angle is between about 5 degrees and about 30 degrees.

3. The apparatus of claim 1, wherein the angle is about 17 degrees.

4. The apparatus of claim 1, wherein the outer perimeter defines a circle.

5. The apparatus of claim 4, wherein the second member of the support structure is collinear with the center of the circle.

6. The apparatus of claim 4, wherein the radius of the circle is between about 3 inches and about 12 inches.

7. The apparatus of claim 4, wherein the first member has a length equal to the radius of the circle.

8. The apparatus of claim 4, wherein the first member has a length greater than the radius of the circle.

9. The apparatus of claim 1, wherein each of the frame and support structure are constructed using steel.

10. The apparatus of claim 1, further comprising a decoy mounting structure adjustably secured to the second member.
